(19) United States
(12) Patent Application Publication
(10) Pub. No.: US 2013/0286686 A1
(43) Pub. Date: Oct. 31, 2013

(54) Optical Light Guide Element For An Electronic Device

(71) Applicants: Ville Kettunen, Ruschlikon (CH); Peter Riel, Bach (CH); Hartmut Rudmann, Jona (CH); Markus Rossi, Jona (CH)

(72) Inventors: Ville Kettunen, Ruschlikon (CH); Peter Riel, Bach (CH); Hartmut Rudmann, Jona (CH); Markus Rossi, Jona (CH)

(73) Assignee: Heptagon Micro Optics Pte. Ltd.

(21) Appl. No.: 13/988,853

(22) PCT Filed: Nov. 23, 2011
(86) PCT No.: PCT/CH11/00288

§ 371 Date: Jul. 17, 2013

Related U.S. Application Data
(60) Provisional application No. 61/418,017, filed on Nov. 30, 2010.

(51) Int. Cl. F21V 8/00

(52) U.S. Cl. CPC G02B 6/0011
USPC 362/623; 362/628

(57) ABSTRACT

The invention relates to an optical light guide element (1) having a first end section (8) with a light entrance area (6) designed for facing a light-transparent opening (50) and having a second end section (9) with a light exit area (7) designed for facing a light sensor (52), wherein the light entrance area (6) is defined by a surface area on the optical light guide element (1) which faces the light-transparent opening (50) and the first end section (8) forms an inclined surface area (2) which has an acute angle with the surface area of the light entrance area (6).

### FIELD OF THE INVENTION

The invention relates to optical light guide elements for electronic devices and to electronic devices containing optical light guide elements.

### BACKGROUND OF THE INVENTION

Portable electronic devices, such as mobile phones, multi-function smart phones, digital media players, digital cameras and navigation devices have display screens that can be used under various lighting environments. Such devices have integrated in them a function that can provide (in real-time) an indication of the current level of visible light in the immediate environment outside the device. This is called an ambient light sensor function (or ALS). The ALS can be used for applications such as automatically managing the brightness of a display screen for better readability or for saving battery energy (depending upon the current ambient light level).

On the market ALS integrated circuit (IC) devices are known that have a built-in solid state light sensor together with associated electronic circuitry that provide, in real-time, a fairly accurate measurement of the ambient visible light that is incident upon the IC device. These IC devices are for the most part manufactured in accordance with a complementary metal oxide semiconductor (CMOS) fabrication process technology.

Typically the light sensor is placed directly under the light-transparent opening in the cover of the electronic device. The incoming light therefore directly impinges on the light sensor. For constructional reasons it may occur that the sensor is not arranged in line with the light-transparent opening, but rather arranged laterally displaced from the light-transparent opening under the cover. For this reason the light which enters through the light-transparent opening has to be guided to the light sensitive surface area of the light sensor. It is well known to guide visible light by means of optical light guide elements such as light pipes made of glass or plastic. However, mobile electronic devices have to be light and small-sized. Therefore, the numerous components within the housing of such an electronic device are normally densely packed and space for additional components is often extremely limited. This means that in such a case there is not a lot of available space for an optical light guide element. However, light guide elements in the state-of-the-art are known for being bulky and for needing a lot of space.

### DESCRIPTION OF THE INVENTION

It is therefore an object of the invention to create an optical light guide element of the type initially mentioned, which overcomes the disadvantages mentioned above.

This object is achieved by an optical light guide element according to claim 1 and an electronic device according to claim 27. The dependent claims comprise further developments of the invention or alternative solutions for the invention.

The optical light guide element according to the invention has a first end section with a light entrance area designed for facing a light source, particularly a light-transparent opening through which (ambient) light passes. The size and shape of the light entrance area is preferably optimized in order to guarantee an optimum performance with respect to light collection efficiency and angular response. Further, the optical light guide element has a second end section with a light exit area designed for facing a light target area, particularly a light sensor, i.e. an opto-electronic sensor. The light entrance area is defined by a surface area on the optical light guide element which faces the light source or the light-transparent opening. The first end section forms an inclined surface area which forms an acute angle with said surface area of the light entrance area. I.e. the light entrance area lies to some degree opposite to this inclined surface.

The inclined resp. slanted surface area is preferably inclined in a direction parallel to the main direction of the light propagation within the light guide element. I.e. the acute angle is formed by the surface lines of the two surface areas in a cross-sectional view along the main direction of the light propagation. The inclined surface of the first end section practicably corresponds to an inclined front face of the optical light guide element. The main direction of the light propagation within the light guide element is defined by a starting point in the first end section and an end point in the second end section.

Additionally or alternatively to the above described inclined surface area being inclined in a direction parallel to the main direction of the light propagation, the optical light guide can contain an inclined surface area which is inclined in a direction transverse to the main direction of the light propagation. In this case the acute angle is formed by the surface lines of the two surface areas in a cross-sectional view transverse to the main direction of the light propagation.

The acute angle between the inclined surface area and the surface area of the light entrance area is preferably at minimum 10°, advantageously at minimum 20°, and most preferably at minimum 30° (angular degree). Further, the acute angle between the inclined surface area and the surface area of the light entrance area is preferably at maximum 80°, advantageously at maximum 70° and most preferably at maximum 60°. The acute angle is e.g. between 40° and 50° and particularly 45°.

The location and dimension of the light entrance area, the location and dimension of the inclined surface of the first end section and the acute angle between the inclined surface and the light entrance are such that at least some, preferably most of the incoming light is reflected on the inclined surface within the optical light guide element. Once the light has entered the light guide element and e.g. has been reflected by the inclined surface for the first time, it propagates from the first end section towards the second end section of the light guide element. The propagation of the light is caused by alternating reflection or refraction on boundary surfaces which extends between the first end section and the second end section. The boundary surfaces can e.g. lie opposite to each other.

The described inclined surface now has the effect that the incoming light, which is reflected on the inclined surface, receives a distinct component of propagation in direction of the second end section. Hence, light which impinges the light guide element in a steep angle and particularly perpendicularly to the light entrance area, resp. in a steep angle and particularly perpendicular to the main direction of the light propagation within the light guide element is redirected in a direction having a component of propagation in direction of the second end section.

Generally, the incoming light and particularly light which impinges the light entrance area at a steep angle, such that the light is reflected on the inclined surface, receives a distinct component towards the second end section, i.e. in the main direction of light propagation within the light guide element. As a result that light is reflected on the mentioned boundary surfaces at flat angles and few reflections on the boundary layers occur till the light beam has reached the second end section. As a result the losses caused by multiple reflections are reduced and therefore the total loss in light transmission is reduced as well.

The light entrance area is preferably defined by a plane surface which faces the light-transparent opening. The plane is preferably orientated perpendicular to the axis of the light-transparent opening. The plane is preferably smooth and uniform. However, the light entrance area and the light exit area can comprise an optical active structure, particularly microstructure, e.g. a lens or a diffuser. Of course, this optical active structure can also be a separate element arranged between the light source or the light-transparent opening and the entrance area and/or between the light target area or the sensor and the light exit area. The optical structures can be replicated in said areas or surfaces during manufacturing of the light guide element. The above mentioned optical active structures can also be provided on the inclined surfaces. The optical active structures can also comprise a coating on the surfaces of the light guide element, such as anti-reflection coatings, color filters, etc. Such coatings can e.g. be applied on the light entrance surface, the light exit surface and/or on the inclined surface in the first and/or second end section.

The term “opening” in the expression “light-transparent opening” means an aperture through which light can pass. The opening can, but does not have to be a physical opening. Usually the light-transparent opening is covered by light-transmissive element or window, e.g. made of glass or plastic. Hence, the light transparent opening can also be named as a light transparent area.

The inclined surface area of the first end section preferably also forms a plane. The inclined surface area can be smooth and uniform. The inclined surface area can also have a surface finish with a specific roughness.

According to a further development of the invention the light exit area of the optical light guide element is defined by a surface area which faces the light target area, particularly the light sensor. The second end section preferably forms also an inclined surface area which encloses an acute angle with the surface area of the light exit area. I.e. the light exit area lies to some degree opposite to the inclined surface area.

The inclined surface area is preferably inclined in a direction parallel to the main direction of the light propagation within the light guide element. I.e. the acute angle is formed by the two surface lines in a cross-sectional view along the main direction of the light propagation. The inclined surface of the second end section practicably corresponds to an inclined front face of the optical light guide element.

Additionally or alternatively to the above described inclined surface area being inclined in a direction parallel to the main direction of the light propagation, the optical light guide can contain an inclined surface area which is inclined in a direction transverse to the main direction of the light propagation. In this case the acute angle is formed between the surface lines of the two surface areas in a cross-sectional view transverse to the main direction of the light propagation.

The location and dimension of the light exit area, the location and dimension of the inclined surface of the second end section and the acute angle between the inclined surface and the light exit are preferably such that at least some of the light, preferably most of the light propagating within the optical light guide from the first end section towards the second end section is reflected on the inclined surface within the optical light guide element towards the light exit area.

The acute angle between said inclined surface area and the light exit area is preferably at minimum 10°, advantageously at minimum 20° and most preferably at minimum 30°. The acute angle between said inclined surface area and the surface area of the light exit area is preferably at maximum 80°, advantageously at maximum 70°, most preferably at maximum 60°. The acute angle is e.g. between 40° and 50° and particularly 45°.

Also here, the light exit area is preferably defined by a plane surface which faces the light target area. The plane is preferably smooth and uniform. The inclined surface area of the second end section preferably also forms a plane surface. The inclined surface area can be smooth and uniform. The inclined surface area can also have a surface finish with a specific roughness.

In between the inclined walls the light guide element contains other surfaces, e.g. upper, lower and side surfaces.

In a preferred further development of the invention the optical light guide element contains a first surface, preferably an upper surface, which comprises the light entrance area, and further contains a second surface, preferably a lower surface, which extends in a distance to the first surface. The second surface contains the light exit area.

According to another embodiment the light guide element contains a first surface, preferably an upper surface, and a second surface, preferably a lower surface, which extends in a distance to the first surface. Both, the light entrance area and the light exit area are located on the first surface.

According to a further embodiment the light guide element contains a first surface, preferably an upper surface, and a second surface, preferably a lower surface, which extends in a distance to the first surface. The first and second surfaces are connected by side surfaces and a front surface in the second end section. The light entrance area is located on the first surface. The light exit area is located in the second end section on the front surface or on a side surface of the light guide element.

The first and second surface preferably also form a boundary surface along which light beams are reflected while propagating from the first end section towards the second end section. The first and second surfaces preferably run parallel to each other.

The mentioned surfaces are shaped in a way to enable the transport of light by reflection or refraction in a most efficient way towards the light exit area.

The optical light guide element is preferably an elongated element which extends from the light-transparent opening to the light sensor. The light guide element is preferably a straight, flat element, e.g. in the form of a slab. The light guide element can also be a curved element. The surfaces or some surfaces of the light guide element can also be curved.

The optical light guide element has preferably a polygonal shape in a cross section transverse to the main direction of the light propagation within the optical light guide element, i.e. transverse to the longitudinal direction of the light guide element. The polygonal shape can e.g. be rectangular, square or trapezoid or a rhomboid. Further the optical light guide element is preferably rhomboid-shaped in a cross-sectional view along the main direction of the light propagation.

In a specific embodiment of the invention the outer contour of the optical light guide element is completely formed by plane surface areas, which abut against each other in different angles. However, it is also possible that at least at some surface areas which form boundary surfaces on which light beams within the light guide element are reflected or refracted contain optical active structures, particularly microstructures, such as lenses, diffusers, optical coatings or gratings. Further the surface areas can also have a surface finish with a specific roughness.

Furthermore in a further development of the invention at least some of the surface areas which form boundary surfaces at which light beams within the light guide element are reflected contain a reflective layer, e.g. in form of a metallic coating. Such a coating can e.g. be made of aluminum. For example some or all of the surfaces which extend between the first and second end section and on which the light which is reflected on the slanted wall is further reflected can be coated with a reflective layer.

The entrance and exit area can be masked, mainly in order to influence the angular sensitivity. In first variant of the invention the light propagation is based on the principle of TIR (Total Internal Reflection). In this case only the inclined surfaces (front faces) have a reflective coating. The other surfaces remain uncoated.

In a second variant of the invention the light propagation is based on reflection. In this case also other surfaces (first, second, i.e. upper, lower and side surfaces) have a reflective coating. Preferably all sides of the light guide element with exception of the light entrance and exit area have a reflective coating (ASC—All Side Coated). I.e., the light entrance area and the light exit area form a window.

As mentioned at the beginning, the optical light guide element has to be adapted to the limited space available within the housing of the electronic device. The light guide element can have a thickness of preferably at minimum 0.1 mm, advantageously of at minimum 0.2 mm. The thickness can be the distance between a first and second surface. Further said thickness is preferably at maximum 1 mm, advantageously at maximum 0.6 mm and most preferably of about 0.3 to 0.5 mm, particularly 0.4 mm.

Further, the optical light guide element preferably has a length of at minimum 2 mm. Further, said length preferably is at maximum 6 mm, advantageously at maximum 5 mm, and most preferably at maximum 4 mm. The light guide element has e.g. a length of about 3 mm. The light guide element is made of a light-transparent material, such as, but not restricted to, glass or plastic. The light guide elements are preferably manufactured on a wafer-scale basis. Such a wafer is cut into numerous light guide elements which may undergo further process steps, e.g. a finishing step after being cut out from the wafer. Of course, the light guide element can also be produced by injection molding or other techniques.

The above used term “light” means light in the visible or near-visible range of electromagnetic wave range. Hence, the term “light” also comprises by definition near infrared (IR) or ultraviolet (UV) light. Further the term “light” can also mean a specific range of electromagnetic waves in the visible or near visible range.

The present invention also comprises an electronic device, with a housing. The housing has integrated therein a cover with a light-transparent opening for passing light into the housing.

The light sensor is arranged below the cover and is laterally displaced from the light-transparent opening. The light-transparent opening is optically connected to the light sensor by means of the optical light guide element as described above. The light guide is arranged below the cover as well and runs between the light-transparent optical opening and the light sensor. The optical light guide element is preferably arranged in a space below a cover of the housing and above an electronic unit within the housing.

The light sensor is preferably an ambient light sensor which serves to sense the ambient light level outside the electronic device. As the response of many typical CMOS light sensor structures (e.g., CMOS photodiodes) is dominated by infrared (IR) content, rather than visible content, an IR blocking filter (IR cut filter) can be placed in front of the sensor, i.e. between the sensor and the light exit area of the optical light guide element to thereby lessen the sensitivity of the sensor's output to IR content. The filter can also be placed between the opening and the light entrance area of the optical light guide element or the filter can be placed as window across the opening itself. Of course, amongst IR blocking filter, also other filters for blocking electromagnetic waves of a specific range can be applied at the mentioned places.

The electronic device is preferably a mobile electronic device, particularly a hand-held, mobile electronic device, such as a mobile phone, a multi-function smart phone, a digital media player, an organizer, a digital camera or a navigation device e.g. with a display screen.

The optical light guide element is not only applicable for collecting and transporting ambient light, which enters the housing of an electronic device through an opening towards a light sensor which is laterally displaced from this opening. The light guide element is also applicable for collecting and transporting (visible) light within an electronic device from a light source, e.g. an LED, to a light target area, e.g. for illuminating the target area, which can e.g. be a display.

The present invention has the advantage that the optical light guide element can capture and guide light, particularly ambient light, with an angle of incident from −60° to +60° to the light target area or light sensor. Further, the efficiency of an on-axis light source is more than 20-25%. The present solution does not have a significant spectral dependency of response. Further, the light guide element is very flat but is able to transport light very efficiently and uniformly over a distance of e.g. several Millimeters.

### DETAILED DESCRIPTION OF PREFERRED EMBODIMENTS

The subject matter of the invention will be explained in more detail in the following text with reference to preferred exemplary embodiments which are illustrated in the attached drawings, in which:

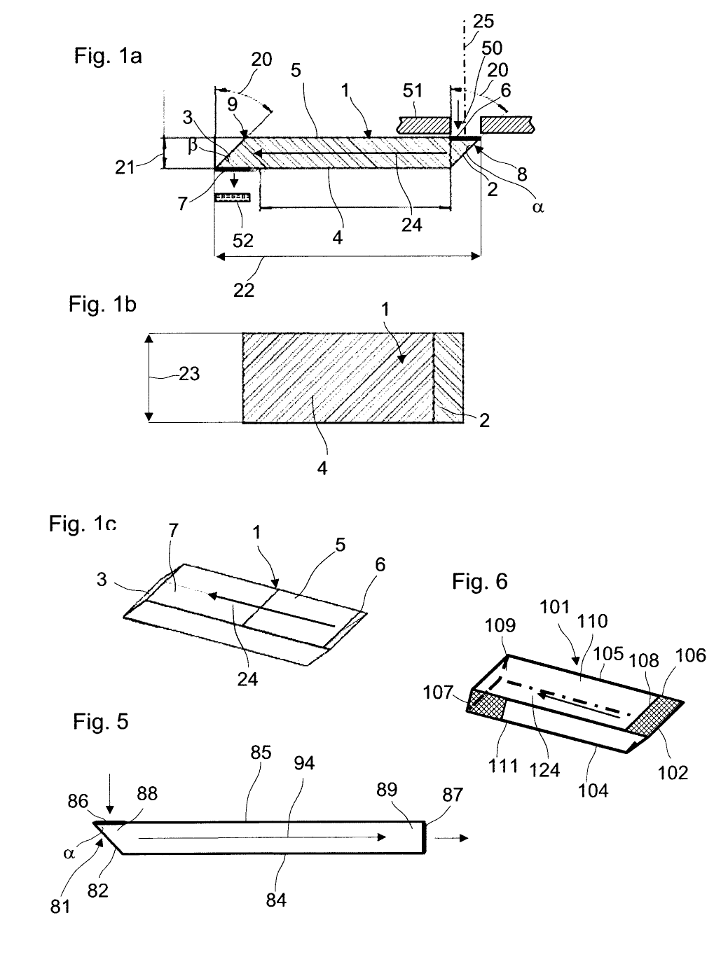

FIGS. 1a . . . c: show different views of a first embodiment of an optical light guide element;

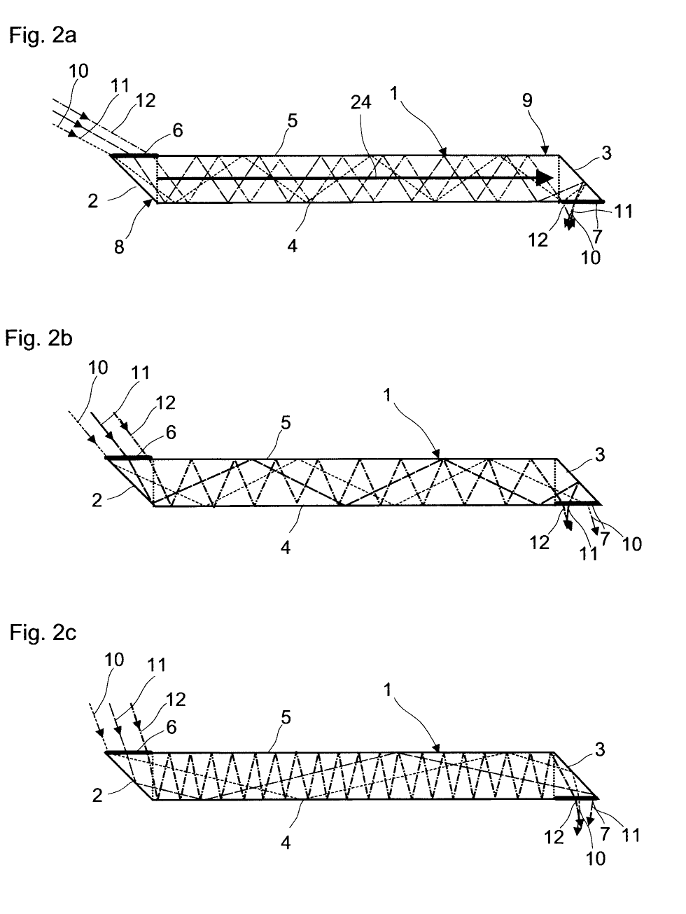

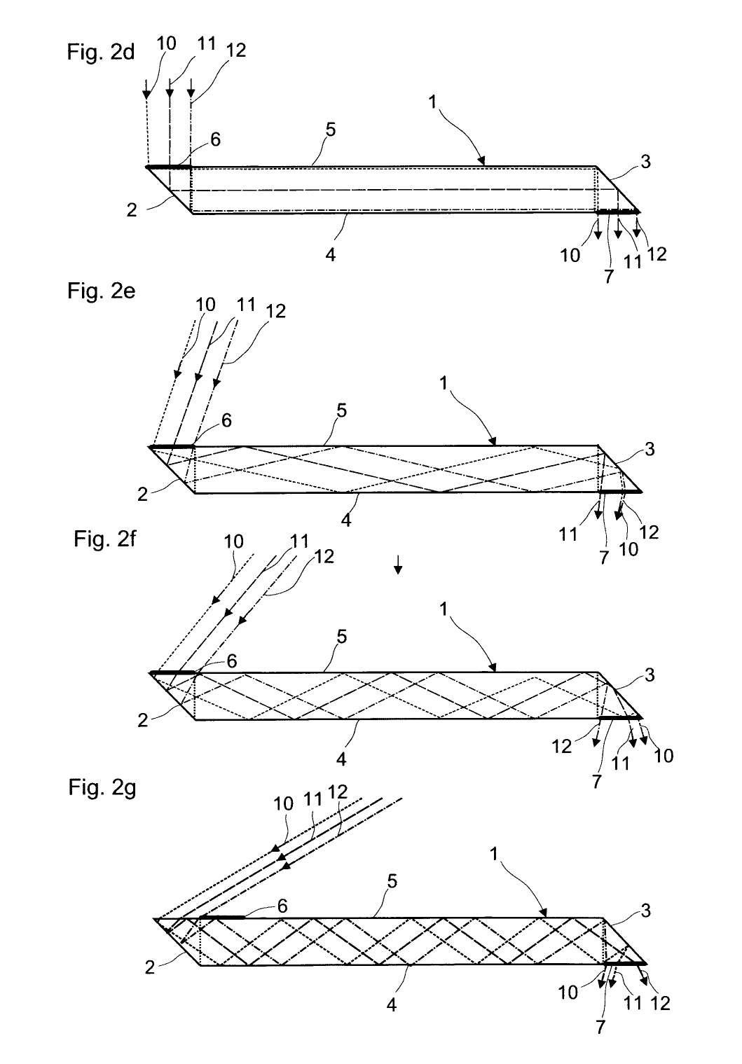

FIGS. 2a . . . g: show the light path within the optical light guide element according to the first embodiment of light beams which impinge the light entrance area from different angles;

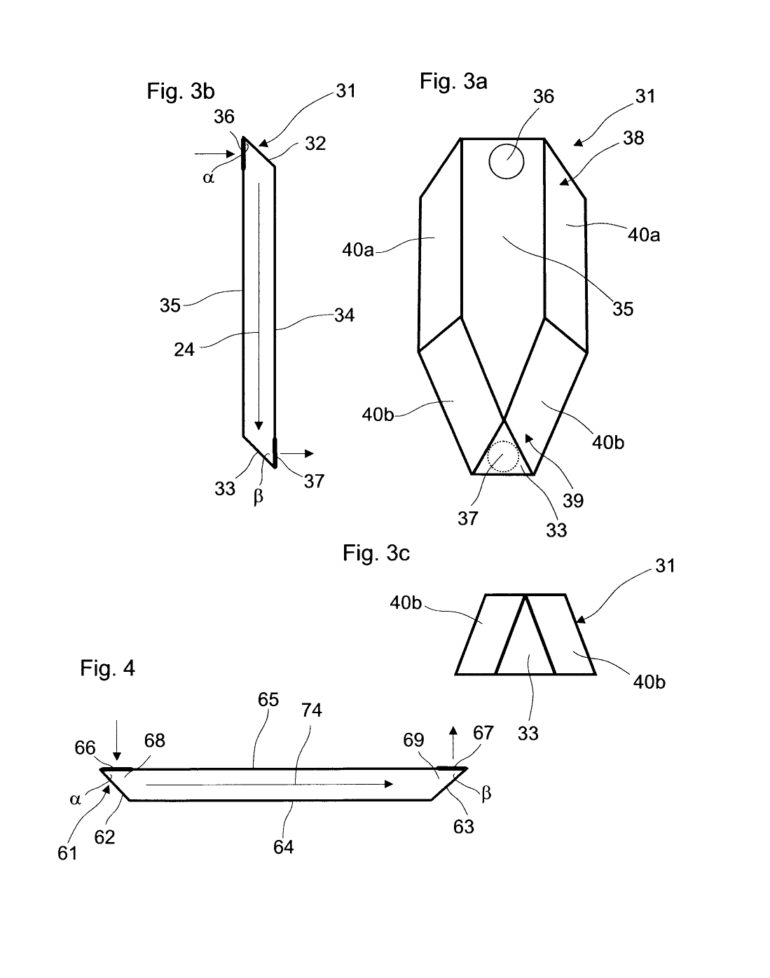

FIGS. 3a . . . c: show different views of a second embodiment of an optical light guide element;

FIG. 4: shows a third embodiment of an optical light guide element;

FIG. 5: shows a fourth embodiment of an optical light guide element;

FIG. 6: shows a fifth embodiment of an optical light guide element.

The reference symbols used in the drawings, and their meanings, are listed in summary form in the list of reference symbols. In principle, identical parts are provided with the same reference symbols in the figures.

The first embodiment of an optical light guide element 1 according to FIG. 1a-1c is formed as a flat element with planar surfaces which has the form of a rhomboid in a cross-section along the main direction of light propagation 24 and which has a rectangular form in a cross-section transverse to said main direction of light propagation 24. FIG. 1a shows a side view and FIG. 1b a top view of the light guide element 1 as shown in a perspective view in FIG. 1c. The light guide element 1 has a first end section 8 in which the light entrance area 6 is located. Opposite to the light entrance area 6 a first inclined surface 2 is arranged. Further, the light guide element 1 has a second end section 9 in which the light exit area 7 is located. Opposite to the light exit area 7 a second inclined surface 3 is arranged. The acute angle α between the light entrance area 6 and the first inclined surface 2 and the acute angle β between the light exit area 7 and the second inclined surface 3 corresponds in this embodiment to the complementary angle 20 and is 45°. Further, the light guide element 1 has a first, e.g. upper surface 5 which contains the light entrance area 6 and a second, e.g. lower surface 4 which contains the light exit area 7. The first and second surfaces 5, 4 are planar surfaces which lie in distance and which run parallel to each other. The light guide element 1 further comprises side surfaces which connect the first and second surfaces 5, 4 and which lie in a distance and opposite to each other and which run parallel to each other. The side surfaces lie perpendicular to the first and second surfaces 5, 4. However, they also may form an angle with the upper and lower surfaces which is different than 90°. I.e. they can be inclined inwards or outwards as viewed from the upper surface.

The light entrance area 6 can face a light-transparent opening 50 in a cover element 51 which is arranged above the light guide element 1. In the present embodiment the light entrance area 6 is a planar surface which is orientated perpendicular to the axis 25 of the opening 50. Further the light exit area 7 can face a light sensor 52 which is arranged below the light guide element. The light sensor can be part of a circuit board equipped with electronics.

The total length 22 of the light guide element 1 is about 3.5 mm. The width 23 is about 1.2 mm and the height 21 is about 0.4 mm. Hence, the light guide element 1 is quite small in comparison to known light guide elements from the state-of-the-art. The surfaces of the light guide element 1 are at least partly coated with aluminum which forms a reflective surface for the propagating light beams within the light guide element 1.

The width of the light entrance area 6 is such that all the light which impinge the light entrance and which is perpendicular, i.e. on-axis, is reflected on the inclined surface 2 adjacent to the light entrance area 6.

FIG. 2 shows a number of examples of light guide elements with incident light which impinges the light entrance area 6 from different angles. The figures also show the light paths within the light guide element resulting thereof. The geometry of the light guide element 1 corresponds basically to the geometry of the embodiment of FIG. 1.

FIG. 2a shows an example with incident light at an angle of 60°. FIG. 2b shows an example with incident light at an angle of 40°. FIG. 2c shows an example with incident light at an angle of 20°. FIG. 2d shows an example with incident light at an angle of 0°. FIG. 2e shows an example with incident light at an angle of −20°. FIG. 2f shows an example with incident light at an angle of −40°. FIG. 2g shows an example with incident light at an angle of −60°.

The series of FIGS. 2a to 2g depictive shows that particularly light with a steep angle of incident which is transmitted through the light guide element 1 with low transmission loss. This is based on the effect, that particularly light with a steep incident angle is reflected on the inclined surface 2 in the first end section 8 and is deflected into a light beam with a pronounced component in the main direction of propagation, i.e. in direction of the second end section. As a result, the light beam is reflected on the surfaces of the light guide element 1 (e.g. upper and lower surface) at a flat angle and the number of reflections along its path towards the second end section 9 is quite low. As the number of multiple reflections is low, also the transmission loss is low. In FIG. 2c the light beam 11, having a steep angle of incidence, does for example not reach the inclined surface 2 when entering the light guide element at the entrance area. As a result, the light beam 11 is reflected on the opposite surface of the light guide element at a steep angle. This has the effect that the light beam does not have a pronounced component of propagation in the main direction of light propagation 24 and therefore is reflected on the surface of the light guide element many times along its path towards the light exit area. As a result the transmission loss is quite high.

The inclined surface 3 in the second end section 9 of light guide element 1 is necessary in order to deflect the light beams with a pronounced component in the main direction of propagation which arrive in the second end section 9 towards the light exit area. Both, inclined surfaces 2, 3 at the first and second end sections 8, 9 form front faces of the light guide element 1.

FIGS. 3a to 3c describe a second embodiment of an inventive optical light guide element 31. FIG. 3b shows a side view and FIG. 3c shows a front view of the light guide element 31 of FIG. 3a. Analogous to the light guide element 1 of the first embodiment in FIGS. 1 and 2, the second embodiment 31 is formed as a flat element with planar surfaces. The light guide element 31 has the form of a rhomboid in a cross-section along to the main direction of light propagation 24. In opposition to the first embodiment 1 the light guide element 31 has the form of a trapezoid in a cross-sectional view transverse to said main direction of light propagation 24.

The light guide element 31 has a first end section 38 in which the light entrance area 36 is arranged. Opposite to the light entrance area 36 a first inclined surface 32 is arranged. Further, the light guide element 31 has a second end section 39 in which the light exit area 37 is arranged. Opposite to the light exit area 37 a second inclined surface 33 is arranged. The light entrance area 36 and the first inclined surface 32 and the light exit area 37 and the second inclined surface 33, respectively, form an acute angle α, β of 45°.

The light guide element 31 has a first, e.g. upper surface 35 which contains the light entrance area 36 and a second, e.g. lower surface 34 which contains the light exit area 37. The first and second surfaces 35, 34 are planar surfaces which lie in distance and which run parallel to each other. The light guide element 31 further comprises side surfaces 40a, 40b which connect the first and second surfaces 35, 34 and which lie in a distance and opposite to each other. First side surfaces 40a, which are arranged in the first end section 38 and which extends towards the second end section 39 run parallel to each other and are inclined outwards. Second side surfaces 40b which also are inclined outwards are adjoining the first side surfaces 40a and extend towards the second end section 39. Said side surfaces 40b run together towards the second end section 39 and delimit the inclined front face 33 in the second end section 39. As an effect of the inclined side surfaces, the light beams which propagate within the light guide element and which hits the side faces also receive a vertical component of propagation which is directed from the first to the second surface.

While the invention has been described in present preferred embodiments of the invention, it is distinctly understood that the invention is not limited thereto, but may be otherwise variously embodied and practised within the scope of the claims.

The third embodiment of an optical light guide element 61 according to FIG. 4 is formed as a flat element with planar surfaces which has the form of a trapezoid in a cross-section along the main direction of light propagation 74 and which has a rectangular form in a cross-section transverse to said main direction of light propagation 74. The light guide element 61 has a first end section 68 in which the light entrance area 66 is located. Opposite to the light entrance area 66 a first inclined surface 62 is arranged. Further, the light guide element 61 has a second end section 69 in which the light exit area 67 is located. Opposite to the light exit area 67 a second inclined surface 63 is arranged. Between the light entrance area 66 and the first inclined surface 62 and between the light exit area 67 and the second inclined surface 63 an acute angle α, β is formed, which is preferably 45°. Further, the light guide element 61 has a first surface 65 and a second surface 64. In comparison to the first embodiment according to FIG. 1 both, the light entrance area 66 and the light exit area 67 are located on the same surface, namely the first surface 65. The first and second surfaces 65, 64 are planar surfaces which lie in distance and which run parallel to each other. The light guide element 61 further comprises side surfaces which connect the first and second surfaces 65, 64 and which lie in a distance and opposite to each other and which run parallel to each other. The side surfaces lie perpendicular to the first and second surfaces 65, 64. However, they also may form an angle with the first and second surfaces which is different than 90°. I.e. they can be inclined inwards or outwards as viewed from the first surface.

The fourth embodiment of an optical light guide element 81 according to FIG. 5 is formed as a flat element with planar surfaces which has a rectangular form in a cross-section transverse to the main direction of light propagation 94. The light guide element 81 has a first end section 88 in which the light entrance area 86 is located. Opposite to the light entrance area 86 a first inclined surface 82 is arranged. Further, the light guide element 81 has a second end section 89 in which the light exit area 87 is located. Between the light entrance area 86 and the first inclined surface 82 an acute angle α, β is formed, which is preferably 45°. Further, the light guide element 81 has a first surface 85 and a second surface 84. The light entrance area 86 is located on the first surface 85. In comparison to the first, second and third embodiment according to FIGS. 1-4 the light exit area 87 is neither located on the first surface nor on the second surface but rather on side surface, namely a front surface. Therefore no slanted surface is necessary which redirects the light in a direction to the first or second surface. The first and second surfaces 85, 84 are planar surfaces which lie in distance and which run parallel to each other. The light guide element 81 further comprises side surfaces which connect the first and second surfaces 85, 84 and which lie in a distance and opposite to each other and which run parallel to each other. The side surfaces lie perpendicular to the upper and lower surfaces 84, 85. However, they also may form an angle with the first and second surfaces which is different than 90°. I.e. they can be inclined inwards or outwards as viewed from the first surface.

The fifth embodiment of an optical light guide element 101 according to FIG. 6 is formed as a flat element with planar surfaces. The light guide element 101 has a first end section 108 in which the light entrance area 106 is located. Opposite to the light entrance area 106 a first inclined surface 102 is arranged. Further, the light guide element 101 has a second end section 109 in which the light exit area 107 is located. Between the light entrance area 106 and the first inclined surface 102 an acute angle is formed, which is preferably 45°. Further, the light guide element 101 has a first surface 105 and a second surface 104. The light entrance area 106 is located on the first surface 105. The first and second surfaces 105, 104 are planar surfaces which lie in distance and which run parallel to each other. The light guide element 101 further comprises side surfaces 110, 110 which connect the first and second surfaces 105, 104 and which lie in a distance and opposite to each other. The side surfaces 110, 111 can lie perpendicular to the first and second surfaces 105, 104. However, they also may form an angle with the first and second surfaces 105, 104 which is different than 90°. I.e. they can be inclined inwards or outwards as viewed from the first surface 105. In comparison to the first, second, third and fourth embodiment according to FIGS. 1-5 the light exit area 107 is neither located on the first surface nor on the second surface or on a front surface but rather on a side surface 111. In this way the light is leaving the light guide element 101 sideward. The geometry of the second end section 109 can be different than shown in FIG. 6. The second end section 109, i.e. the surfaces thereof, have preferably a geometry which optimally guides the light sideward through the light exit area 107.

LIST OF DESIGNATIONS

| | |
|---|---|
| 1 | optical light guide element |
| 2 | inclined surface of the 1^{st} end section |
| 3 | inclined surface the 2^{nd} end section |
| 4 | 2^{nd} surface |
| 5 | 1^{st} surface |
| 6 | light entrance area |
| 7 | light exit area |
| 8 | 1^{st} end section |
| 9 | 2^{nd} end section |
| 10 | 1^{st} light beam |
| 11 | 2^{nd} light beam |
| 12 | 3^{rd} light beam |
| 20 | complementary angle |
| 21 | height of the light guide element |
| 22 | length of the light guide element |
| 23 | width of the light guide element |
| 24 | main direction of light propagation |
| 25 | axis of the opening |
| 31 | optical light guide element |
| 32 | inclined surface the 1^{st} end section |
| 33 | inclined surface of the 2^{nd} end section |
| 34 | 1st surface |
| 35 | 2^{nd} surface |
| 36 | light entrance area |
| 37 | light exit area |
| 38 | 1^{st} end section |
| 39 | 2^{nd} end section |
| 40a | 1^{st} side surface |
| 40b | 2^{nd} side surface |
| 50 | light-transparent opening |
| 51 | cover element |
| 52 | Light sensor |
| 61 | optical light guide element |
| 62 | inclined surface of the 1^{st} end section |
| 63 | inclined surface the 2^{nd} end section |
| 64 | 2^{nd}surface |
| 65 | 1st surface |
| 66 | light entrance area |
| 67 | light exit area |
| 68 | 1^{st} end section |
| 69 | 2^{nd} end section |
| 74 | main direction of light propagation |
| 81 | optical light guide element |
| 82 | inclined surface of the 1^{st} end section |
| 84 | 2^{nd} surface |
| 85 | 1st surface |
| 86 | light entrance area |
| 87 | light exit area |
| 88 | 1^{st} end section |
| 89 | 2^{nd} end section |
| 94 | main direction of light propagation |
| 101 | optical light guide element |
| 102 | inclined surface of the 1^{st} end section |
| 104 | 2^{nd} surface |
| 105 | 1st surface |
| 106 | light entrance area |
| 107 | light exit area |
| 108 | 1^{st} end section α angle |
| 109 | 2^{nd} end section β angle |
| 124 | main direction of light propagation |

1. An optical light guide element comprising:
a first end section with a light entrance area designed for facing a light source, and
a second end section with a light exit area designed for facing a light target area,
wherein the light entrance area is defined by a surface area on the optical light guide element which faces the light source, and
wherein the first end section comprises an inclined surface area which forms an acute angle with the surface area of the light entrance area.

2. The optical light guide element of claim 1, wherein the light entrance area is designed for facing a light-transparent opening in a cover through which the light is passing.

3. The optical light guide element of claim 1, wherein the inclined surface area is inclined in the main direction of the light propagation within the light guide element and the acute angle is formed by the surface lines of the inclined surface and the light entrance area in a cross-sectional view along the main direction of the light propagation.

4. The optical light guide element of claim 1, wherein the inclined surface of the first end section corresponds to an inclined front face of the optical light guide element.

5. The optical light guide element of claim 1, wherein the inclined surface area is inclined in a direction transverse to the main direction of the light propagation within the light guide element and the acute angle is formed by the surface lines of the inclined surface and the light entrance area in a cross-sectional view transverse to the main direction of the light propagation.

6. The optical light guide element of claim 1, wherein the acute angle between the inclined surface area and the surface area of the light entrance area is at minimum 10° and at maximum 80°.

7. The optical light guide element of claim 1, wherein the light entrance area is defined by a plane which faces the light source or the light-transparent opening.

8. The optical light guide element of claim 1, wherein the inclined surface area of the first end section forms a plane.

9. The optical light guide element of claim 1, wherein the light exit area is defined by a surface area of the optical light guide element which faces the light target area and wherein the second end section forms an inclined surface area which encloses an acute angle with the surface area of the light exit area.

10. The optical light guide element of claim 1, wherein the light target area is a light sensor.

11. The optical light guide element of claim 10, wherein the inclined surface area is inclined in the main direction of the light propagation and the acute angle is formed by the surface lines of the inclined surface and the light entrance area in a cross-sectional view along the main direction of the light propagation.

12. The optical light guide element of claim 10, wherein the inclined surface of the second end section corresponds to an inclined front face of the optical light guide element.

13. The optical light guide element of claim 10, wherein the inclined surface area is inclined in a direction transverse to the main direction of the light propagation within the light guide element, and the acute angle is formed by the surface lines of the inclined surface and the light entrance area in a cross-sectional view transverse to the main direction of the light propagation.

14. The optical light guide element of claim 10, wherein the acute angle between the inclined surface area and the surface area of the light entrance area is at minimum 30° and at maximum 60°.

15. The optical light guide element of claim 10, wherein the light exit area is defined by a plane which faces the light target area.

16. The optical light guide element of claim 10, wherein the inclined surface area of the second end section forms a plane.

17. The optical light guide element of claim 1, wherein the optical light guide element contains a first surface which comprises the light entrance area and a second surface which comprises the light exit area, and wherein the second surface runs parallel and in a distance to the first surface.

18. The optical light guide element of claim 1, wherein the optical light guide element is an elongated element which extends from the light source to the light target area.

19. The optical light guide element of claim 1, wherein the optical light guide element has a polygonal shape in a cross section transverse to the main direction of the light propagation within the optical light guide element.

20. The optical light guide element of claim 1, wherein the optical light guide element is rhomboid-shaped in a cross-sectional view along the main direction of the light propagation within the light guide element.

21. The optical light guide element of claim 1, wherein the optical light guide element is formed by plane surface areas, which abut against each other in an angle.

22. The optical light guide element of claim 17, wherein the optical light guide element is a flat element and the distance between the first and second surface is at minimum 0.1 mm.

23. The optical light guide element of claim 1, wherein the distance between the first and second end sections of the optical light guide element is at minimum 2 mm and at maximum 5 mm.

24. The optical light guide element of claim 1, wherein the location and dimension of the light entrance area, the location and dimension of the inclined surface of the first end section and the acute angle between the inclined surface and the light entrance are such that at least some of the incoming light between an angle of incident of −30° and 30° is reflected on the inclined surface of the first end section within the optical light guide element.

25. The optical light guide element of claim 1, wherein the location and dimension of the light exit area, the location and dimension of the inclined surface of the second end section and the acute angle between the inclined surface and the light exit are such that at least some of the light propagating within the optical light guide from the first end section towards the second end section is reflected on the inclined surface of the second end section within the optical light guide element towards the light exit area.

26. The optical light guide element of claim 1, wherein the surfaces of the optical light guide element are at least partially coated with a reflective layer.

27. The optical light guide element of claim 26, wherein the reflective layer is a metallic layer.

28. An electronic device, comprising an optical light guide element having a first end section with a light entrance area designed for facing a light source and having a second end section with a light exit area designed for facing a light target area, the light guide element is designed and arranged within the electronic device for transporting light from a light source to a light target area, wherein the light source and the light target area are not located along a common axis.

29. The electronic device of claim 28
wherein the light entrance area is defined by a surface area on the optical light guide element which faces the light source, and
wherein the first end section comprises an inclined surface area which forms an acute angle with the surface area of the light entrance area.

30. The electronic device of claim 28, comprising:
a housing having integrated therein:
a cover with a light-transparent opening for passing light into the housing;
a light sensor, being arranged below the cover and being laterally displaced from the light-transparent opening;
wherein the light-transparent opening is optically connected to the light sensor by means of the optical light guide element, wherein the light guide element is arranged below the cover an extends between the light-transparent optical opening and the light sensor.

31. The electronic device of claim 30, wherein the light sensor is an ambient light sensor.

32. The electronic device of claim 28, wherein the optical light guide element is arranged below a cover of the housing and above an electronic unit within the housing.
